(19) United States
(12) Patent Application Publication
(10) Pub. No.: US 2022/0009168 A1
(43) Pub. Date: Jan. 13, 2022

(54) ATTACHMENTS FOR OPTICAL SHAPING APPARATUS

(71) Applicant: TKR CORPORATION, Tokyo (JP)

(72) Inventors: Eiji OSHIMA, Tokyo (JP); Shunsuke NIREI, Tokyo (JP)

(21) Appl. No.: 17/240,175

(22) Filed: Apr. 26, 2021

(30) Foreign Application Priority Data
Apr. 24, 2020 (JP) 2020-077462

(51) Int. Cl. B29C 64/286; B33Y 30/00

(52) U.S. Cl. CPC B29C 64/286; B33Y 30/00

(57) ABSTRACT

The present invention provides an attachment for stereolithography apparatus enabling manufacturing of patterns of various sizes. The attachment for stereolithography apparatus includes: a base portion 301 detachable to a manufacturing table of a stereolithography apparatus; placement platform pillars 302a through 302d provided on the base portion 301; and a sheet placement platform 303 supported by the placement platform pillars 302a through 302d. The base portion 301 has a first opening 301a configured to allow the light beam from the optical scanning section to pass through, and the sheet placement platform 303 has a second opening 303a configured to allow the light beam from the optical scanning section to pass through. The placement platform pillars 302a through 302d support the sheet placement platform 303 in a position causing a distance from the optical scanning section of the stereolithography apparatus to the sheet placement platform 303 to be longer than a distance from the optical scanning section to the manufacturing table.

### BACKGROUND OF THE INVENTION

### 1. Field of the Invention

The present invention relates to an attachment for stereolithography apparatus to be attached to a stereolithography apparatus to harden a photocurable resin by a laser light source or the like for manufacturing in a desired shape.

### 2. Description of the Related Art

For the purpose of low-volume high-variety production, reduction in the prototyping period, reduction in the development costs, and the like, the additive manufacturing technology, so-called 3D printers, receives attention. Manufacturing processes of the 3D printers include various processes. Among all, vat photopolymerization (stereolithography) to selectively solidify a photocurable resin with light for manufacturing of a three-dimensional shape enables fine and high resolution three-dimensional manufacturing and is expected to be developed as a method of producing various products.

As a 3D printer employing the stereolithographic process, there is, for example, a stereolithography apparatus described in US Patent Application No. 2017/0291355. The stereolithography apparatus in US Patent Application No. 2017/0291355 uses Digital Light Processing® (DLP®) as a radiation mechanism. Use of DLP as a radiation mechanism allows irradiation cross-sectional data of a three-dimensional shape at a time.

### SUMMARY

Manufacturing by the stereolithographic process is also applicable to, for example, manufacture circuit boards (circuit sheets) and the like. While development and prototyping of circuit boards used to take a period of several months, use of a 3D printer is expected to greatly reduce the development period and the prototyping period. In the development and prototyping of circuit boards, it is common to revise, modify, and thus improve circuit patterns and manufacturing of circuit patterns of various sizes is strongly intended in the development and prototyping stages.

While the stereolithography apparatus described in US Patent Application No. 2017/0291355 is capable of manufacturing circuit patterns, the size of such a circuit pattern depends on the distance from the DLP to the manufacturing surface. Although extension of the distance from the DLP to the manufacturing surface allows expansion of the projection area, it causes the projected image to be blurred and it is thus difficult to manufacture a circuit pattern with high resolution. It should be noted that such a problem is not limited to manufacturing of circuit patterns and is a common problem in manufacturing of two-dimensional patterns by existing stereolithography apparatuses.

It is an object of the present invention to provide an attachment for stereolithography apparatus enabling manufacturing of patterns of various sizes. In particular, it is to provide an attachment for stereolithography apparatus enabling manufacturing of patterns in a variety of sizes taking advantage of the characteristics of the focus free stereolithography apparatus.

An attachment for stereolithography apparatus of the present invention is being fixed in a position away from a manufacturing table and detachable to a stereolithography apparatus to form a pattern by irradiating a pattern forming sheet with a light beam emitted from an optical scanning section facing the pattern forming sheet across the manufacturing table, and the attachment for stereolithography apparatus includes: a base portion detachable to the manufacturing table; a support mechanism provided on the base portion; and a sheet placement platform supported by the support mechanism. The base portion has a first opening configured to allow the light beam from the optical scanning section to pass through, and the sheet placement platform has a second opening configured to allow the light beam from the optical scanning section to pass through. The support mechanism supports the sheet placement platform in a position causing a distance from the optical scanning section to the sheet placement platform to be longer than a distance from the optical scanning section to the manufacturing table.

In the attachment for stereolithography apparatus of the present invention, the support mechanism supports the sheet placement platform in the position causing the distance from the optical scanning section to the sheet placement platform to be longer than the distance from the optical scanning section to the manufacturing table. Relative to the optical scanning section, the sheet placement platform is located farther than the manufacturing table.

As described above, the size of a pattern to be manufactured on a pattern forming sheet is determined by the scanning zone of the light beam radiated on the pattern forming sheet. If the scanning zone with the light beam emitted from the optical scanning section is fixed, the size of the pattern to be manufactured on the pattern forming sheet depends on the distance from the optical scanning section to the pattern forming sheet. According to the above configuration, the distance from the optical scanning section to the sheet placement platform is extended more than that of the stereolithography apparatus in the past. Thus, by placing the pattern forming sheet on the sheet placement platform, the scanning zone with the light beam is expanded on the pattern forming sheet and it is possible to manufacture patterns of size greater than before. Meanwhile, since the base portion is detachable to the manufacturing table, in the case of not attaching the attachment for stereolithography apparatus of the present invention to the manufacturing table, it is possible to manufacture patterns of size smaller than the case of attaching the attachment for stereolithography apparatus by directly fixing the pattern forming sheet to the manufacturing table or indirectly fixing to the manufacturing table via a jig and the like. Accordingly, the attachment for stereolithography apparatus of the present invention enables manufacturing of patterns of various sizes from smaller size to larger size.

In the attachment for stereolithography apparatus configured as above, it is desirable that the sheet placement platform is a plate member in a rectangular shape and the second opening is a through hole in a rectangular shape at center of the sheet placement platform.

Although the circuit boards and the circuit sheets may be in various shapes, the circuit boards and the circuit sheets in a rectangular shape are most frequently used from the perspective of versatility and costs. In addition, the applications are not limited to manufacturing of circuit patterns on circuit boards and the like and also often includes manufacturing of arbitrary patterns on rectangular sheets. It is possible to efficiently manufacture a pattern by configuring the sheet placement platform in a rectangular shape and placing the pattern forming sheet on which a photocurable resin or the like is applied at the center. By thus providing the through hole in a rectangular shape at the center of the rectangular plate material, it is possible to achieve weight reduction of the sheet placement platform and improve the convenience of attaching and detaching the attachment for stereolithography apparatus.

In the attachment for stereolithography apparatus configured as above, it is desirable that the base portion is a plate member in a rectangular shape, and the first opening is a through hole in a rectangular shape provided at center of the base portion.

By thus forming the base portion in a rectangular shape and providing the through hole in a rectangular shape at the center, it is possible to achieve weight reduction of the base portion and even more increase the convenience of attaching and detaching the attachment for stereolithography apparatus.

In the attachment for stereolithography apparatus configured as above, it is desirable that the support mechanism has a columnar shape and provided substantially vertical to the base portion.

According to such a configuration of the support mechanism, it is possible to achieve weight reduction of the attachment for stereolithography apparatus and also manufacture patterns of various sizes with a simple configuration.

In the attachment for stereolithography apparatus configured as above, it is even more desirable that, when the base portion is the rectangular plate material and the first opening is the through hole provided at the center of the base portion, the support mechanism includes columnar members provided at the four corners of the base portion.

Since the attachment for stereolithography apparatus according to the present invention is configured to have the sheet placement platform supported by the support mechanism, there may be a concern that the pattern manufacturing accuracy is affected by vibration during manufacturing and the like depending on the configuration of the support mechanism. By providing the support mechanism as the columnar members at the four corners of the base portion, it is possible to support the sheet placement platform in a stable state. It is thus possible to preferably inhibit a decrease in pattern manufacturing accuracy due to the vibration of the sheet placement platform during manufacturing and the like.

It is desirable that the attachment for stereolithography apparatus configured as above further includes a sheet holding mechanism configured to bias the pattern forming sheet against the sheet placement platform.

In this configuration where the pattern forming sheet is sandwiched between the sheet placement platform and the sheet holding mechanism, it is possible to suppress the lift-off of the pattern forming sheet and thus to perform pattern manufacturing with high accuracy.

The attachment for stereolithography apparatus of the present invention allows stereolithography apparatuses to manufacture patterns of various sizes.

### BRIEF DESCRIPTION OF THE DRAWINGS

FIG. 1 is a perspective view illustrating a stereolithography apparatus with a standard attachment attached thereto.

FIG. 2 is a perspective view of the stereolithography apparatus illustrated in FIG. 1 taken from below.

FIG. 3 is a perspective view of an attachment for stereolithography apparatus according to the present embodiment.

FIG. 4 is an exploded perspective view of the attachment for stereolithography apparatus illustrated in FIG. 3.

FIG. 5 is a perspective view illustrating a stereolithography apparatus in a state of having the attachment for stereolithography apparatus illustrated in FIG. 3 attached thereto.

FIG. 6 is a front view of the stereolithography apparatus illustrated in FIG. 5.

FIG. 7 is a cross-sectional view of the stereolithography apparatus illustrated in FIG. 6 taken along A-A.

FIG. 8 is a perspective view of the stereolithography apparatus illustrated in FIG. 5 taken from below.

### DETAILED DESCRIPTION OF THE PREFERRED EMBODIMENTS

Embodiments of the present invention are described below in detail with reference to the drawings.

An attachment for stereolithography apparatus according to the present embodiment is assumed to be attached to a stereolithography apparatus employing the vat photopolymerization (stereolithographic) process to selectively solidify a photocurable resin with light, such as a laser light source, for manufacturing.

Taking manufacturing of a circuit pattern on a pattern forming sheet on which a photocurable resin is applied as an example, the attachment for stereolithography apparatus according to the present embodiment is described below. Although manufacturing of a circuit pattern is described here as an example, the applicable manufacturing pattern is not limited to a circuit pattern and may be letters, a design, and the like. It should be noted that, although the present embodiment is described using an example of manufacturing on a flat pattern forming sheet, the pattern forming sheet does not have to be flat and may be curved. Such a stereolithography apparatus allows pattern manufacturing on curved sheets and objects having a curved surface, for example, on a glass surface and the like.

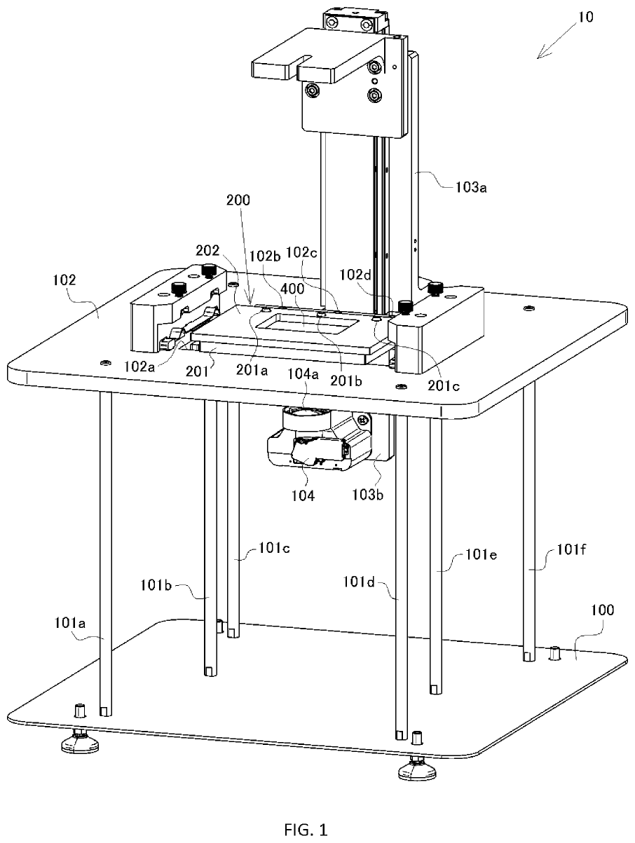

The basic configuration the stereolithography apparatus is first described. As illustrated in FIG. 1, a stereolithography apparatus 10 has a foundation 100 in a flat plate shape, columnar manufacturing table pillars 101a, 101b, 101c, 101d, 101e, and 101f extending above from an upper surface of the foundation 100, and a manufacturing table 102 in a flat plate shape supported by these six pillars 101a through 101f. The manufacturing table 102 has a size substantially identical to that of the foundation 100 and has a peripheral area supported by the manufacturing table pillars 101a through 101f. It should be noted that the foundation 100 is provided with adjuster bolts (adjusting legs) screwed into the four corners on a bottom surface side to allow horizontal adjustment of an upper surface of the manufacturing table 102.

The manufacturing table 102 is provided with a rectangular opening 102a at the center. On an upper surface near one of the long sides of the opening 102a, attachment fixation pins 102b, 102c, and 102d are provided projecting at regular intervals in parallel with the long side of the opening 102a. Outside these attachment fixation pins 102b through 102d, a substantially rectangular parallelepiped column 103a is provided vertically above from the upper surface of the manufacturing table 102. In addition, a column 103b is provided projecting vertically below from a bottom surface of the manufacturing table 102.

Below the approximate center of the opening 102a of the manufacturing table 102, an optical engine 104 as an optical scanning section is fixed to the column 103b via a bracket. The optical engine 104 has: a light source, such as a laser light source; optical elements, such as a collimator lens and a reflective mirror; and a two-dimensional microelectromechanical systems (MEMS) mirror. A light beam emitted from the light source is incident on the two-dimensional MEMS mirror via the optical elements. The two-dimensional MEMS mirror is an electromagnetically driven mirror and is capable of rotating in two-dimensional directions. The light beam reflected by the two-dimensional MEMS mirror scans following the movement of the two-dimensional MEMS mirror. Between the optical engine 104 and the manufacturing table 102, a condenser lens 104a is fixed with the same bracket as that of the optical engine 104. The light beam emitted from the optical engine 104 scans through the condenser lens 104a.

The attachment for stereolithography apparatus according to the present embodiment is then described using an example of manufacturing two kinds of small and large circuit patterns. Although a description given here is on manufacturing of two kinds of small and large circuit patterns as an example, the size of the circuit pattern to be manufactured is not limited to two kinds. It should be noted that, for the convenience of the description, an attachment for manufacturing a small circuit pattern is referred to as a “standard attachment” and an attachment for stereolithography apparatus according to the present embodiment as an “extension attachment”.

FIG. 1 is a perspective view of a state of the stereolithography apparatus 10 having a standard attachment 200 attached thereto. The standard attachment 200 is provided with a standard sheet placement platform 201 in a rectangular shape and a standard sheet holding plate 202 in a rectangular shape. The standard sheet placement platform 201 and the standard sheet holding plate 202 are provided with respective rectangular openings at the center.

On an upper surface of the standard sheet placement platform 201 near one of the long sides of the opening, standard sheet positioning pins 201a, 201b, and 201c are provided projecting at regular intervals in parallel with the long side of the opening. In the standard sheet placement platform 201, through holes (attachment fixation holes) allowing the attachment fixation pins 102b through 102d of the manufacturing table 102 to be fit therein are provided perforating outside the standard sheet positioning pins 201a through 201c. That is, the upper surface of the standard sheet placement platform 201 is provided with the standard sheet positioning pins 201a through 201c and the attachment fixation holes in two rows from the opening to the outside.

On a bottom surface of the standard sheet holding plate 202 near one of the long sides of the opening, through holes (sheet fixation holes) allowing the standard sheet positioning pins 201a through 201c to be fit therein are provided by perforation.

A pattern forming sheet 400 has one surface on which a photocurable resin is applied. The pattern forming sheet 400 has a peripheral area on the side of one of the long sides provided with through holes (sheet positioning holes) allowing the standard sheet positioning pins 201a through 201c to be fit therein.

To attach the standard attachment 200 to the stereolithography apparatus 10, firstly, the attachment fixation holes of the standard sheet placement platform 201 are fit over, by insertion, the attachment fixation pins 102b through 102d of the manufacturing table 102 to fix the standard sheet placement platform 201 to the manufacturing table 102. Then, the sheet positioning holes of the pattern forming sheet 400 are fit over, by insertion, the standard sheet positioning pins 201a through 201c of the standard sheet placement platform 201 to place the pattern forming sheet 400 on the standard sheet placement platform 201. In this operation, the surface on which a photocurable resin is applied of the pattern forming sheet 400 is directed below, that is, to the optical engine 104 side.

Then, the sheet fixation holes of the standard sheet holding plate 202 are fit over, by insertion, the standard sheet positioning pins 201a through 201c projecting from the sheet positioning holes of the pattern forming sheet 400 to place the standard sheet holding plate 202 on the pattern forming sheet 400. The pattern forming sheet 400 is thus fixed in a state of being sandwiched between the standard sheet placement platform 201 and the standard sheet holding plate 202. Since the sheet positioning holes of the pattern forming sheet 400 are fit over, by insertion, the respective standard sheet positioning pins 201a through 201c of the standard sheet placement platform 201, displacement of the pattern forming sheet 400 caused by vibration of the stereolithography apparatus and the like is inhibited.

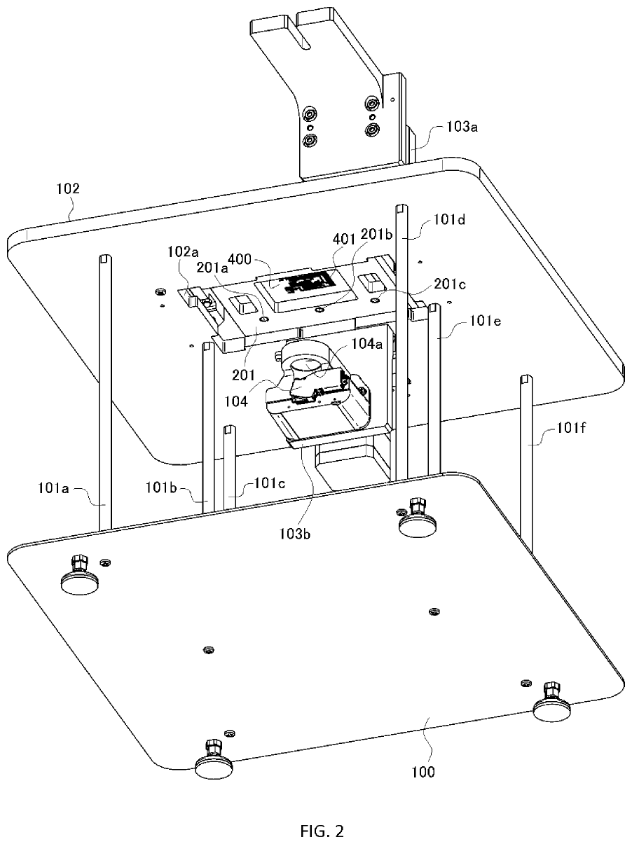

When the pattern forming sheet 400 is irradiated with the light beam from the optical engine 104 while the pattern forming sheet 400 is fixed to the standard attachment 200 in such a manner, the photocurable resin in the irradiated area is hardened. As illustrated in FIG. 2, a standard circuit pattern 401 is manufactured on the pattern forming sheet 400 by scanning by the optical engine 104.

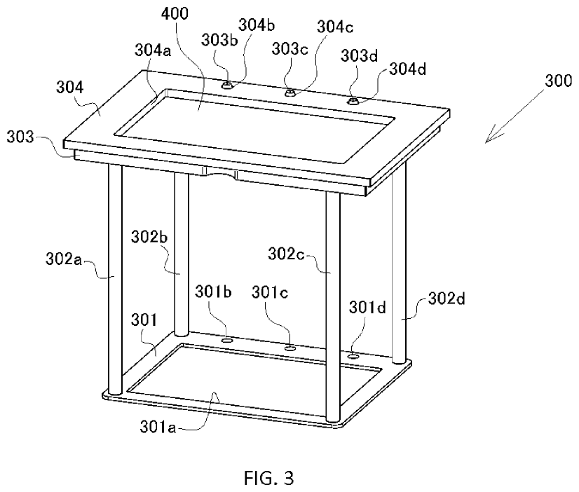

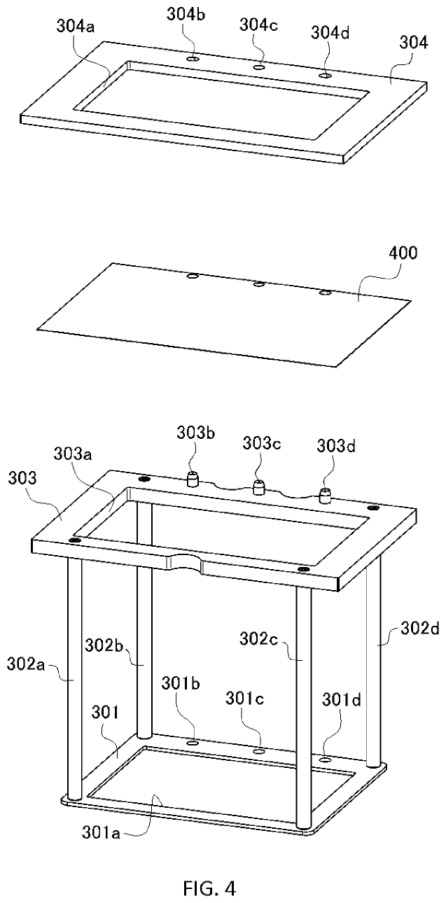

Then, the extension attachment is described. As illustrated in FIGS. 3 and 4, an extension attachment 300 has: a base portion 301; columnar placement platform pillars 302a, 302b, 302c, and 302d extending above from the four corners of the base portion 301; and a sheet placement platform 303 supported by and also fixed to the placement platform pillars 302a through 302d. The extension attachment 300 further has a sheet holding plate 304. It should be noted that, in the attachment for stereolithography apparatus according to the present embodiment, the base portion 301 is equivalent to the base portion, the placement platform pillars 302a through 302d to the support mechanism, the sheet placement platform 303 to the sheet placement platform, and the sheet holding plate 304 to the sheet holding mechanism, respectively.

The base portion 301 in the present embodiment has a flat quadrilateral frame shape. To describe in detail, the base portion 301 is a rectangular plate material provided with a first opening 301a, which is a through hole in a rectangular shape, at the center. As through holes allowing the attachment fixation pins 102b through 102d of the manufacturing table 102 to be fit therein, attachment fixation holes 301b, 301c, and 301d are provided perforating an upper surface of the base portion 301 on a side of one of the long sides in parallel with the direction of penetrating the first opening 301a.

The sheet placement platform 303 has a substantially similar shape slightly larger than the base portion 301. To describe in detail, the sheet placement platform 303 is a rectangular plate material and provided with a second opening 303a, which is a through hole in a rectangular shape, at the center. The second opening 303a has an opening area slightly larger than that of the first opening 301a of the base portion 301.

On an upper surface of the sheet placement platform 303 on a side of one of the long sides of the second opening 303a, sheet positioning pins 303b, 303c, and 303d in a shape identical to that of the attachment fixation pins 102b through 102d of the manufacturing table 102 are provided projecting in one row at a pitch identical to the attachment fixation pins 102b through 102d. These sheet positioning pins 303b through 303d have an outer diameter identical to that of the attachment fixation pins 102b through 102d. In the present embodiment, it should be noted that the direction of a line connecting the centers of the respective sheet positioning pins 303b through 303d, that is, the direction of aligning the sheet positioning pins 303b through 303d is parallel to the direction of aligning the attachment fixation pins 102b through 102d and that each of the sheet positioning pins 303b through 303d and each of the attachment fixation pins 102b through 102d are located on the respective same line in the direction orthogonal to the alignment directions.

The base portion 301, the placement platform pillars 302a through 302d, and the sheet placement platform 303 described above are integrally formed in a substantially hexahedral skeleton shape as a whole. Since all the placement platform pillars 302a through 302d in the present embodiment have the same shape, the base portion 301 and the sheet placement platform 303 are aligned via the placement platform pillars 302a through 302d.

The sheet holding plate 304 has a substantially similar shape slightly larger than the sheet placement platform 303. The sheet holding plate 304 is provided with a third opening 304a, which has a substantially shape identical to that of the second opening 303a of the sheet placement platform 303, at the center. As through holes allowing the sheet positioning pins 303b through 303d of the sheet placement platform 303 to be fit therein, sheet fixation holes 304b, 304c, and 304d are provided perforating a bottom surface of the sheet holding plate 304 on a side of one of the long sides in parallel with the direction of penetrating the third opening 304a. The sheet fixation holes 304b through 304d do not have to be through holes. For example, blind holes corresponding to the sheet fixation holes 304b through 304d may be formed in the bottom surface of the sheet holding plate 304 by providing the sheet holding plate 304 with a thickness slightly thicker than the projecting length of the sheet positioning pins 303b through 303d.

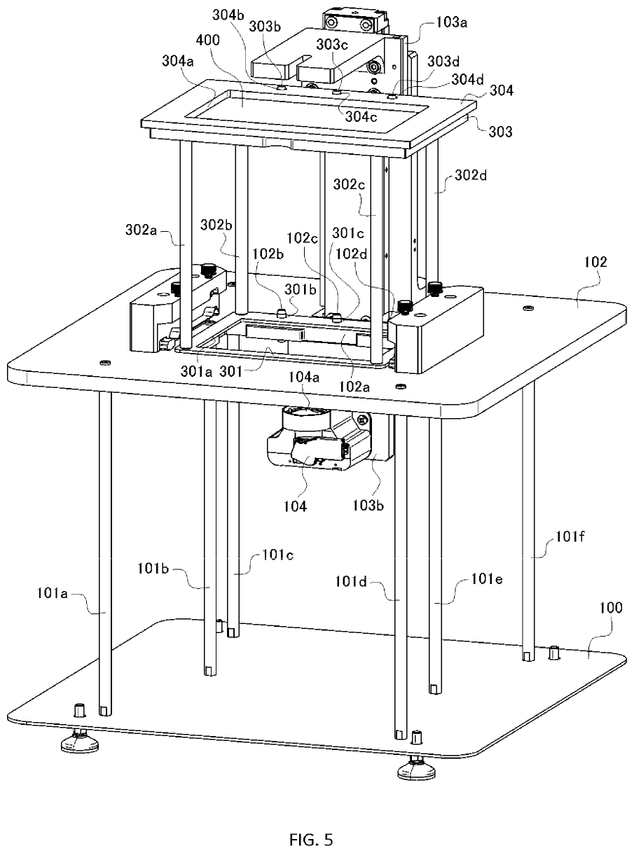

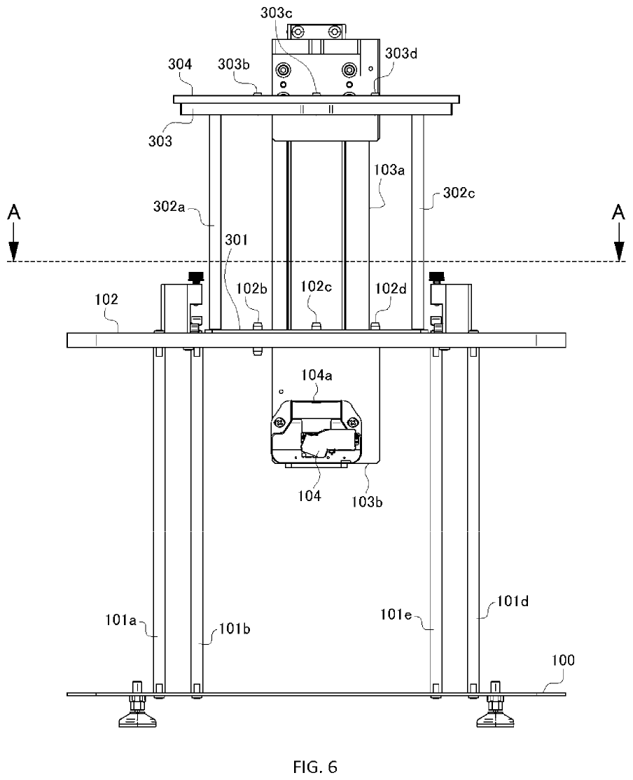

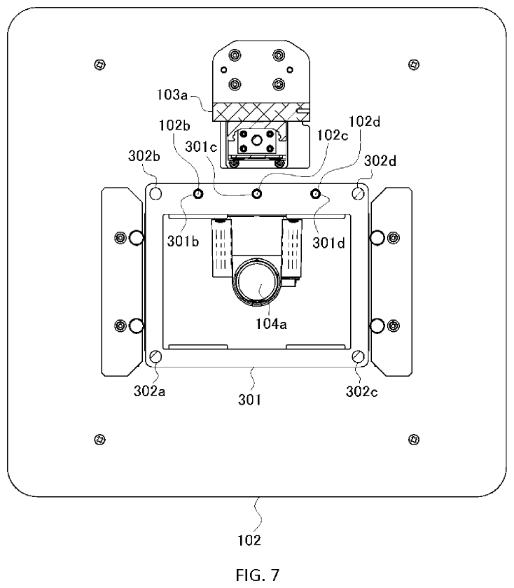

As illustrated in FIGS. 5 through 7, to attach the extension attachment 300 to the stereolithography apparatus 10, firstly, the attachment fixation holes 301b through 301d of the base portion 301 are fit over the attachment fixation pins 102b through 102d by insertion to fix the base portion 301 to the manufacturing table 102. The sheet positioning holes of the pattern forming sheet 400 are then fit over, by insertion, the sheet positioning pins 303b through 303d of the sheet placement platform 303 to place the pattern forming sheet 400 on the sheet placement platform 303. Since the sheet positioning holes of the pattern forming sheet 400 and the sheet positioning pins 303b through 303d thus fit to each other, displacement of the pattern forming sheet 400 due to the vibration of the stereolithography apparatus and the like is inhibited. It should be noted that, in this operation, the surface on which a photocurable resin is applied of the pattern forming sheet 400 is directed to the optical engine 104 side.

Then, the sheet fixation holes 304b through 304d of the sheet holding plate 304 are fit over, by insertion, the sheet positioning pins 303b through 303d projecting from the sheet positioning holes of the pattern forming sheet 400 to place the sheet holding plate 304 on the pattern forming sheet 400. The pattern forming sheet 400 is fixed in a state of being sandwiched between the sheet placement platform 303 and the sheet holding plate 304 and also is biased against the sheet placement platform 303 by the own weight of the sheet holding plate 304. Such a configuration suppresses the lift-off of the pattern forming sheet 400.

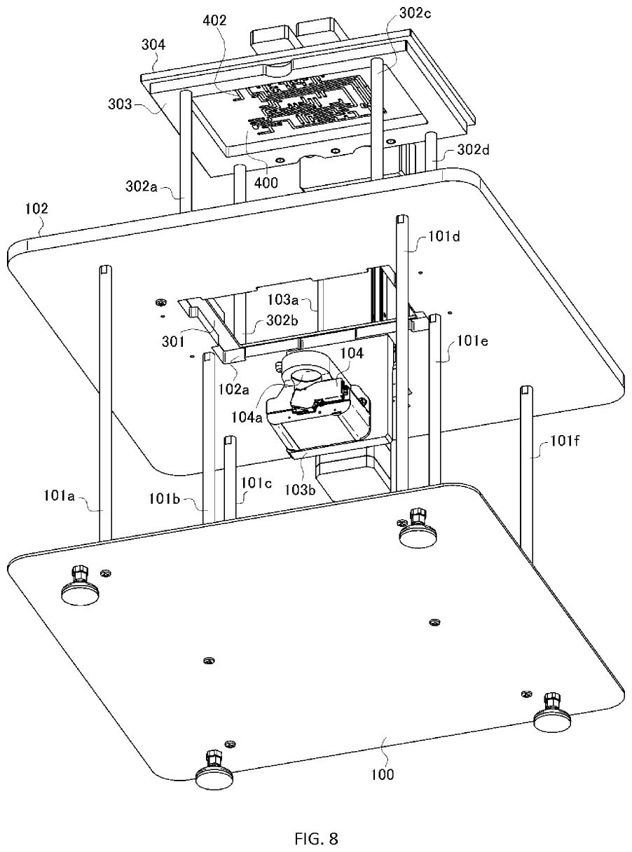

When the pattern forming sheet 400 is irradiated with the light beam from the optical engine 104 while the pattern forming sheet 400 is fixed to the extension attachment 300, the photocurable resin in the irradiated area is hardened. As illustrated in FIG. 8, an expansion circuit pattern 402 is manufactured on the pattern forming sheet 400 by scanning by the optical engine 104.

As illustrated in FIGS. 2 and 8, even when the optical engine 104 has the same scanning zone, manufacturing by attaching the extension attachment 300 allows manufacturing of larger circuit patterns compared with the case of attaching the standard attachment 200. It is also possible to manufacture circuit patterns of a smaller size (standard size) by detaching the extension attachment 300 and attaching the standard attachment 200. The attachment for stereolithography apparatus according to the present embodiment thus enables manufacturing of two kinds of small and large circuit patterns using a stereolithography apparatus.

It should be noted that the attachment for stereolithography apparatus according to the present invention is not limited to the above embodiment. By providing sheet placement platforms in a plurality of stages, it is possible to manufacture patterns of various sizes. For example, by providing a second sheet placement platform aligned further above the sheet placement platform 303, the two stages of platforms allow manufacturing of three kinds of large, middle, and small patterns.

In the above embodiment, the support mechanism is embodied in the columnar placement platform pillars 302a through 302d. The shape of the placement platform pillars 302a through 302d is not limited to the columnar shape. For example, the placement platform pillars may be triangular pillars or quadrangular pillars or may be pillars in a shape of truncating the distal end of a cone, a triangular pyramid, or a quadrangular pyramid. Although the sheet placement platform 303 in the present embodiment was supported by the four placement platform pillars 302a through 302d, the number of the placement platform pillars is not limited to four. The placement platform pillars may have the strength capable of supporting the sheet placement platform 303, and the sheet placement platform 303 may be configured to be supported by one to three or five or more placement platform pillars.

Moreover, the support mechanism is not limited to columnar members. For example, the sheet placement platform may be configured to be supported by four flat plates surrounding the space between the base portion and the sheet placement platform. The sheet placement platform may be configured to be continuously moved in a vertical direction by driving a motor. In other words, the support mechanism may be configured to support the sheet placement platform in a position causing the distance from the optical scanning section to the sheet placement platform to be longer than the distance from the optical scanning section to the manufacturing table.

In the above embodiment, the sheet placement platform 303 is in a rectangular shape and has the second opening 303a in a rectangular shape. The shape of the sheet placement platform is not limited to a rectangular shape. The shape of the sheet placement platform may be appropriately modified depending on the shape of a sheet and the like to form a pattern. For example, in the case of a pattern forming sheet in a circular shape, the sheet placement platform may be formed in a circular shape and provided with a second opening in a circular shape at the center. The position to provide the second opening does not have to be the center of the sheet placement platform. Similarly, the shapes of the base portion and the sheet holding plate are not limited to the rectangular shapes according to the present embodiment.

In view of an increase in the scanning zone of the MEMS mirror with more distance from the optical engine 104, the first opening 301a of the base portion 301 in the above embodiment has an opening area slightly smaller than the opening area of the second opening 303a of the sheet placement platform 303. The opening area of the first opening 301a may have dimensions to the extent of not blocking the light from the optical engine 104 and may be substantially identical to the opening area of the second opening 303a.

In the above embodiment, the attachment fixation holes 301b through 301d of the base portion 301 are fit over, by insertion, the attachment fixation pins 102b through 102d provided projecting in the stereolithography apparatus to attach the attachment for stereolithography apparatus to the stereolithography apparatus, and the state of fitting, by insertion, between the attachment fixation pins 102b through 102d and the attachment fixation holes 301b through 301d is removed to detach the attachment for stereolithography apparatus from the stereolithography apparatus. However, the method of attaching and detaching the attachment for stereolithography apparatus to and from the stereolithography apparatus is not limited to fitting and removing using the pins and the holes. For example, if the manufacturing table of the stereolithography apparatus is ferromagnetic metal or the like, the attachment for stereolithography apparatus may be configured to be attached to and detached from the stereolithography apparatus by the force of a magnet provided on the manufacturing surface side of the base portion. As another example, the base portion may be configured to be fixed to the stereolithography apparatus by screwing screws into threaded holes formed in the positions of the attachment fixation pins of the manufacturing table.

In the above embodiment, the third opening 304a is provided at the center of the sheet holding plate 304. The shape of the third opening 304a is not limited to a rectangular shape. For example, the third opening 304a may be formed in a circular shape. The sheet holding plate 304 may be configured to be formed in a flat plate shape provided with no opening at the center.

In the above embodiment, the pattern forming sheet 400 is biased against the sheet placement platform 303 by the own weight of the sheet holding plate 304 and this allows prevention of the lift-off of the pattern forming sheet 400. The method of biasing the pattern forming sheet 400 against the sheet placement platform 303 is not limited to this. For example, the sheet placement platform 303 may be provided with a leaf spring or a clip to bias the pattern forming sheet 400 against the sheet placement platform 303 by the force of the leaf spring or the clip. The sheet holding mechanism may be configured to allow the pattern forming sheet to be biased against the sheet placement platform and the shape and the mechanism are not limited.

Thus, application of the attachment for stereolithography apparatus according to the above embodiment to a stereolithography apparatus enables manufacturing of patterns of various sizes.

### INDUSTRIAL APPLICABILITY

The present invention is applicable as an attachment to be attached to a stereolithography apparatus for manufacturing of patterns of various sizes.

1. An attachment for stereolithography apparatus, being fixed in a position away from a manufacturing table and detachable to a stereolithography apparatus to form a pattern by irradiating a pattern forming sheet with a light beam emitted from an optical scanning section facing the pattern forming sheet across the manufacturing table, the attachment for stereolithography apparatus comprising:
a base portion detachable to the manufacturing table;
a support mechanism provided on the base portion; and
a sheet placement platform supported by the support mechanism, wherein
the base portion has a first opening configured to allow the light beam from the optical scanning section to pass through,
the sheet placement platform has a second opening configured to allow the light beam from the optical scanning section to pass through, and
the support mechanism supports the sheet placement platform in a position causing a distance from the optical scanning section to the sheet placement platform to be longer than a distance from the optical scanning section to the manufacturing table.

2. The attachment for stereolithography apparatus according to claim 1, wherein
the sheet placement platform is a plate member in a rectangular shape and
the second opening is a through hole in a rectangular shape at center of the sheet placement platform.

3. The attachment for stereolithography apparatus according to claim 1, wherein
the base portion is a plate member in a rectangular shape, and
the first opening is a through hole in a rectangular shape provided at center of the base portion.

4. The attachment for stereolithography apparatus according to claim 1, wherein the support mechanism has a columnar shape and provided substantially vertical to the base portion.

5. The attachment for stereolithography apparatus according to claim 1, further comprising a sheet holding mechanism configured to bias the pattern forming sheet against the sheet placement platform.

6. The attachment for stereolithography apparatus according to claim 2, wherein
the base portion is a plate member in a rectangular shape, and
the first opening is a through hole in a rectangular shape provided at center of the base portion.

7. The attachment for stereolithography apparatus according to claim 2, wherein the support mechanism has a columnar shape and provided substantially vertical to the base portion.

8. The attachment for stereolithography apparatus according to claim 3, wherein the support mechanism has a columnar shape and provided substantially vertical to the base portion.

9. The attachment for stereolithography apparatus according to claim 2, further comprising a sheet holding mechanism configured to bias the pattern forming sheet against the sheet placement platform.

10. The attachment for stereolithography apparatus according to claim 3, further comprising a sheet holding mechanism configured to bias the pattern forming sheet against the sheet placement platform.

11. The attachment for stereolithography apparatus according to claim 4, further comprising a sheet holding mechanism configured to bias the pattern forming sheet against the sheet placement platform.
